(19) United States
(12) Patent Application Publication
(10) Pub. No.: US 2009/0088041 A1
(43) Pub. Date: Apr. 2, 2009

(54) DISPLAY SUBSTRATE MANUFACTURING METHOD AND VACUUM PROCESSING APPARATUS

(75) Inventors: Masato Inoue, Chigasaki-shi (JP); Shin Matsui, Fujisawa-shi (JP)

Correspondence Address: FITZPATRICK CELLA HARPER & SCINTO, 30 ROCKEFELLER PLAZA, NEW YORK, NY, 10112, US

(73) Assignee: CANON ANELVA CORPORATION, Kawasaki-shi (JP)

(21) Appl. No.: 12/235,183

(22) Filed: Sep. 22, 2008

(30) Foreign Application Priority Data
Sep. 25, 2007 (JP) 2007-246904
Sep. 18, 2008 (JP) 2008-239708

(51) Int. Cl. H01J 9/38; H01J 9/385

(52) U.S. Cl. 445/73; 445/56

(57) ABSTRACT

A display substrate manufacturing method includes a placing step of placing a dummy substrate on a clamping surface, an evacuating step of evacuating the interior of a space formed between the clamping surface and dummy substrate, in order to bring the dummy substrate into tight contact with the clamping surface, a heating step of heating a base in order to facilitate removing, from the clamping surface, foreign particles sticking to the clamping surface, a transferring step of transferring the foreign particles sticking to the clamping surface from the clamping surface to the dummy substrate in tight contact with the clamping surface, and a removing step of removing, from the clamping surface, the dummy substrate to which the foreign particles are transferred in the transferring step.

### BACKGROUND OF THE INVENTION

1. Field of the Invention

The present invention relates to a method of manufacturing a display substrate such as a flat panel display, and a vacuum processing apparatus.

2. Description of the Related Art

An electrostatic clamping is used as a means for fixing a substrate to be processed in a substrate processing apparatus such as a semiconductor manufacturing apparatus or flat panel display manufacturing apparatus. In a substrate processing apparatus like this, processing is performed in a state in which a substrate is fixed on the electrostatic clamping by its electrostatic clamping force. After the processing is completed, the substrate is released from the electrostatic clamping by removing the electrostatic clamping force. Thus, substrates are repetitively clamped to and released from the electrostatic clamping in the substrate processing apparatus having the electrostatic clamping.

On the clamping surface of the electrostatic clamping, which is brought into direct contact with a substrate, contamination gradually progresses compared to the initial clean state when the clamping surface is repetitively brought into contact with substrates. This tendency becomes significant as the productivity of the apparatus increases and the number of substrates to be processed increases.

The clamping performance deteriorates when a contaminant adheres to the clamping surface of the electrostatic clamping. The clamping force of the electrostatic clamping can be restored by cleaning the clamping surface of the electrostatic clamping. As a means for this purpose, it is possible to remove the electrostatic clamping from the substrate processing apparatus, and clean the electrostatic clamping in the same manner as in the manufacturing process of the electrostatic clamping.

Unfortunately, it is unrealistic to remove the electrostatic clamping from the completed substrate processing apparatus because an enormous work scale is required. In addition, the sizes of electrostatic clamping are recently increasing as the sizes of substrates to be processed increase. This further increases the demerit of the work of removing the electrostatic clamping.

Also, to increase the substrate processing speed of the substrate processing apparatus and require a clean process, demands have arisen for automatically cleaning the surface of the electrostatic clamping without any operators. To this end, Japanese Patent Laid-Open No. 11-251417 has proposed a means for preventing the adhesion of foreign particles by forming a special coating on the electrostatic clamping surface of an electrostatic clamping.

FIG. 3 is a view showing an outline of the arrangement of the electrostatic clamping according to the prior art disclosed in Japanese Patent Laid-Open No. 11-251417. FIG. 3 shows the base of the electrostatic clamping. This electrostatic clamping is capable of holding a substrate on a substrate holding surface made up of an insulator layer 1001 and a plurality of conductive layers 1002. In this arrangement, the conductive layers 1002 are stacked as they are scattered on the clamping surface. This makes it possible to largely reduce the adhesion of formed conductive foreign particles to a substrate as an object to be clamped. It is also possible to suppress and prevent the decrease in clamping force caused by the existence of foreign particles.

Japanese Patent Laid-Open No. 2002-26115 has disclosed a means for raising the temperature of the clamping surface of an electrostatic clamping by emitting electromagnetic waves (thermal radiation) to the electrostatic clamping, as a holding means for holding the surface condition of the electrostatic clamping constant in order to remove the residual electric charge of the electrostatic clamping.

FIG. 4 is a view showing an outline of the arrangement of the electrostatic clamping according to the prior art disclosed in Japanese Patent Laid-Open No. 2002-26115. As shown in FIG. 4, an electrostatic clamping 2001 clamps and holds a work piece (substrate) 2002. The electrostatic clamping 2001 shown in FIG. 4 has an arrangement in which lamps 2003 and 2004 installed in positions opposing the clamping surface of the electrostatic clamping 2001 emit radiation to the electrostatic clamping 2001. If residual electric charge exists on the electrostatic clamping 2001, this residual electric charge acts as a resistance when releasing the work piece (substrate) 2002 from the electrostatic clamping 2001. This makes it impossible to rapidly remove the work piece (substrate) 2002 from the electrostatic clamping 2001. By contrast, the residual electric charge of the electrostatic clamping 2001 shown in FIG. 4 can be removed by emitting radiation to the electrostatic clamping 2001 from the lamps 2003 and 2004. Therefore, the work piece (substrate) 2002 can be rapidly removed from the electrostatic clamping 2001.

Unfortunately, the electrostatic clamping having the arrangement shown in FIG. 3 increases the apparatus cost because an additional function such as a coating must be formed in the arrangement of the electrostatic clamping. As described previously, the sizes of electrostatic clamping are recently increasing as the sizes of substrates to be processed increase. Accordingly, the cost of a coating or the like also significantly increases.

Furthermore, the means for raising the temperature by emitting electromagnetic waves to the surface of an electrostatic clamping as shown in FIG. 4 can achieve the effect of removing the residual electric charge of the electrostatic clamping. However, almost no effect of removing foreign particles sticking to the clamping surface of the electrostatic clamping can be expected. This is so because the electrostatic clamping shown in FIG. 4 has no adhered foreign particle removing path corresponding to a charge moving path after high-temperature processing. That is, although the application of external energy to the clamping surface of the electrostatic clamping facilitates removing foreign particles attached to the clamping surface of the electrostatic clamping, the foreign particles do not leave the clamping surface of the electrostatic clamping but remain on the surface. Therefore, the foreign particles may adhere to the clamping surface of the electrostatic clamping again if the application of external energy to the clamping surface of the electrostatic clamping is stopped.

### SUMMARY OF THE INVENTION

It is an object of the present invention to provide a display substrate manufacturing method and vacuum processing apparatus capable of removing foreign particles sticking to the clamping surface of an electrostatic clamping by a simple method within a short time period, in the manufacturing process of a display substrate such as a flat panel display.

According to one aspect of the present invention, there is provided a display substrate manufacturing method of a display substrate manufacturing apparatus having a base having a clamping surface made of an insulating material, an electrode formed inside the base to generate an electrostatic clamping force for clamping a substrate placed on the clamping surface, heating means formed inside the base to heat the base, and evacuating means for evacuating an interior of a space formed between the substrate placed on the clamping surface and the clamping surface, the method comprising: a placing step of placing a dummy substrate different from the substrate on the clamping surface; an evacuating step of evacuating the interior of the space by the evacuating means, in order to bring the dummy substrate into tight contact with the clamping surface; a heating step of heating the base by the heating means, in order to facilitate removing, from the clamping surface, foreign particles sticking to the clamping surface; a transferring step of transferring the foreign particles sticking to the clamping surface from the clamping surface to the dummy substrate in tight contact with the clamping surface; and a removing step of removing, from the clamping surface, the dummy substrate to which the foreign particles are transferred in the transferring step.

According to another aspect of the present invention, there is provided a display substrate manufacturing method of a display substrate manufacturing apparatus having a base having a clamping surface made of an insulating material, an electrode formed inside the base to generate an electrostatic clamping force for clamping a substrate placed on the clamping surface, heating means formed inside the base to heat the base, and evacuating means for evacuating an interior of a space formed between the substrate placed on the clamping surface and the clamping surface, the method comprising: a placing step of placing a dummy substrate different from the substrate on the clamping surface; a heating step of heating the base by the heating means, in order to facilitate removing, from the clamping surface, foreign particles sticking to the clamping surface; an evacuating step of evacuating the interior of the space by the evacuating means, in order to bring the dummy substrate into tight contact with the clamping surface; a transferring step of transferring the foreign particles sticking to the clamping surface from the clamping surface to the dummy substrate in tight contact with the clamping surface; and a removing step of removing, from the clamping surface, the dummy substrate to which the foreign particles are transferred in the transferring step.

According to still another aspect of the present invention, there is provided a vacuum processing apparatus comprising: an electrostatic clamping formed by arranging a plurality of electrostatic clamping members in the same plane, each electrostatic clamping member including a base having a clamping surface made of an insulating material, an electrode formed inside the base to generate an electrostatic clamping force for clamping a substrate placed on the clamping surface, heating means formed inside the base to heat the base, and an evacuation through hole formed through the base to communicate with the clamping surface; a clamping power supply which applies a voltage to the electrode formed in each of the plurality of electrostatic clamping members; a heater power supply which applies a voltage to the heating means formed in each of the plurality of electrostatic clamping members; and a vacuum pump connected to the evacuation through hole formed in each of the plurality of electrostatic clamping members.

The display substrate manufacturing method of the present invention can remove foreign particles attached to the clamping surface of an electrostatic clamping by a simple method within a short time period.

Further features of the present invention will become apparent from the following description of exemplary embodiments with reference to the attached drawings.

### BRIEF DESCRIPTION OF THE DRAWINGS

FIG. 1A is a sectional view showing an outline of the arrangement of an electrostatic clamping forming a display substrate manufacturing apparatus according to an embodiment of the present invention;

FIG. 15 is a flowchart for explaining the process of a display substrate manufacturing method according to an embodiment of the present invention;

FIG. 2 is a perspective view showing an outline of the arrangement of a flat panel display film formation apparatus (vacuum processing apparatus) as an example of a vacuum processing apparatus to which the present invention is applicable;

FIG. 3 is a view showing an outline of the arrangement of an electrostatic clamping according to a prior art; and

FIG. 4 is a view showing an outline of the arrangement of an electrostatic clamping according to another prior art.

### DESCRIPTION OF THE EMBODIMENTS

Embodiments of the present invention will be explained below with reference to the accompanying drawings.

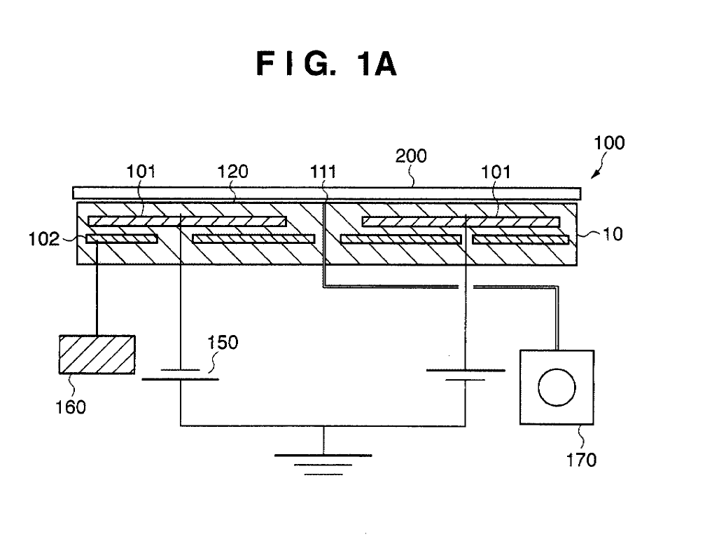

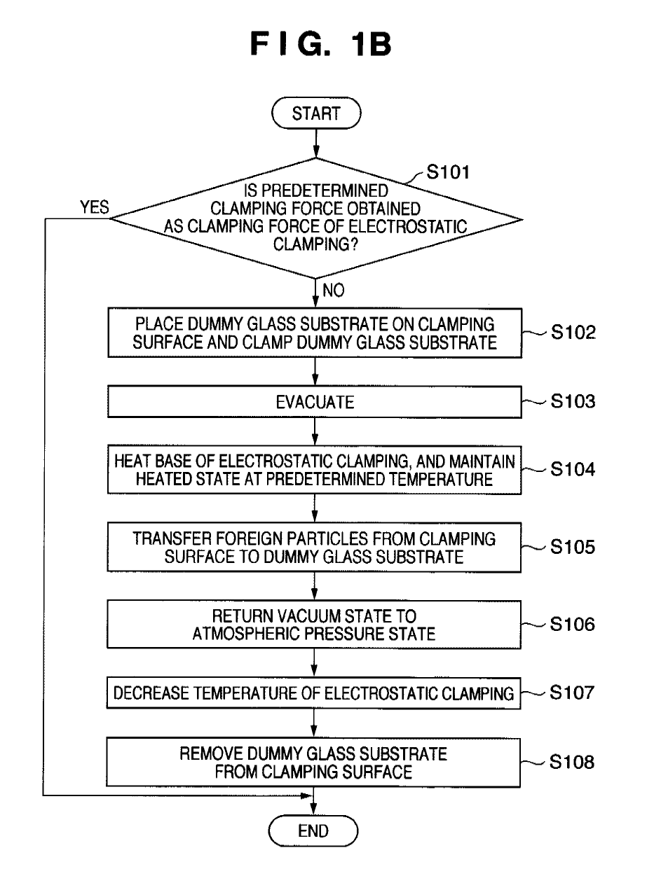

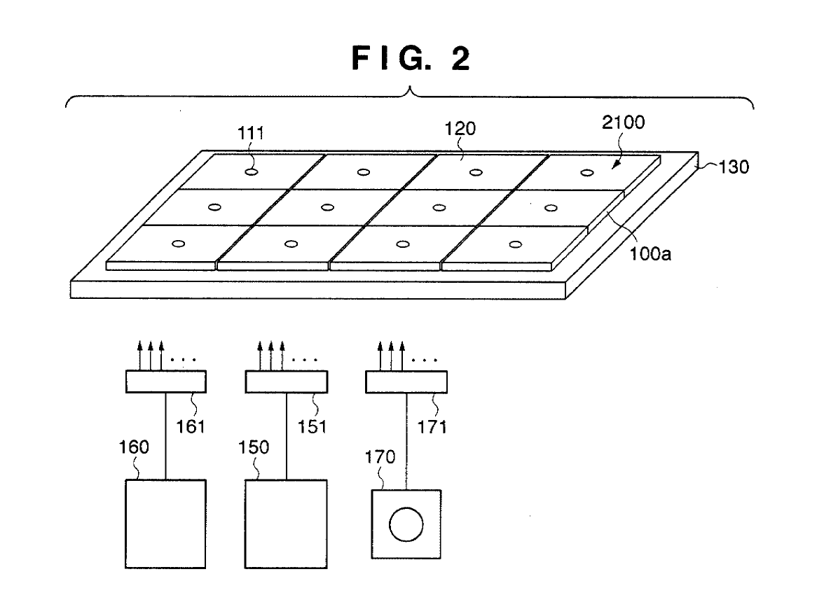

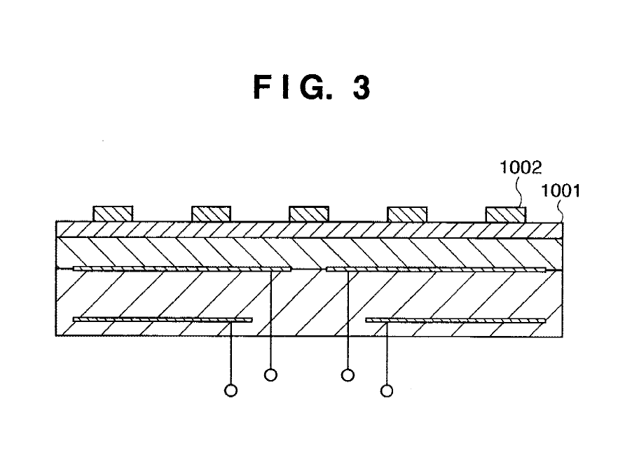

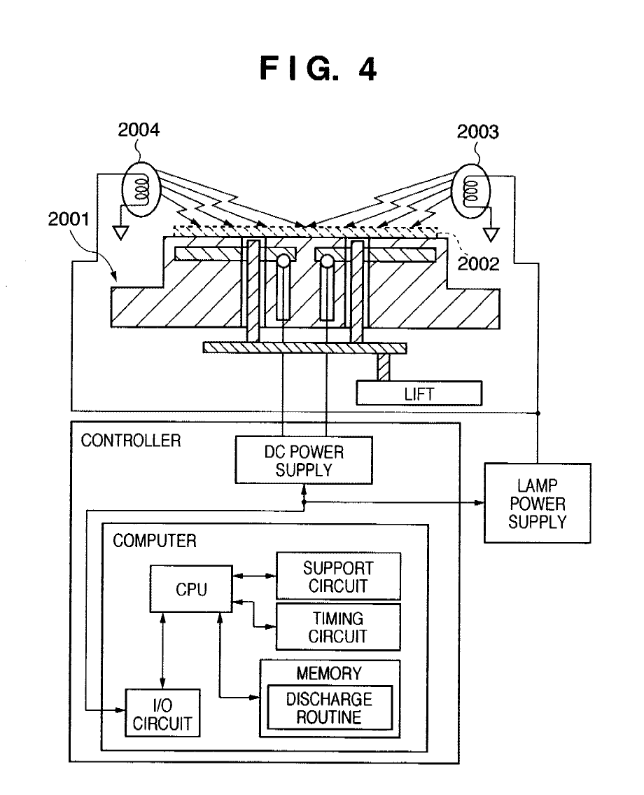

FIG. 1A is a sectional view showing an outline of the arrangement of an electrostatic clamping forming a display substrate manufacturing apparatus according to an embodiment of the present invention.

A base 10 of an electrostatic clamping 100 forming the display substrate manufacturing apparatus incorporates a clamping electrode 101 for generating an electrostatic clamping force on a clamping surface 120, and a built-in heater 102 as a heating means for heating the electrostatic clamping 100. The clamping electrode 101 is electrically connected to a clamping power supply 150, and the built-in heater 102 is electrically connected to a built-in heater power supply 160. These power supplies supply electric power. The clamping electrode 101 and the clamping power supply 150 function as an electrostatic clamping force generating means for generating an electrostatic clamping force for clamping a substrate placed on the clamping surface of the electrostatic clamping 100. An evacuation through hole 111 is also formed in the electrostatic clamping 100. The evacuation through hole 111 extends through the clamping surface 120 and the opposite surface so as to communicate with the clamping surface 120. The piping of the evacuation through hole 111 is connected to an opening in the surface of the electrostatic clamping 100 away from the clamping surface 120. A vacuum pump 170 is connected to the other end of this piping, thereby forming an evacuating means.

The electrostatic clamping 100 is normally used to fix a glass substrate 200 when processing it. This processing of the glass substrate 200 is performed on the surface of the glass substrate 200 away from the surface in contact with the clamping surface 120 of the electrostatic clamping 100. The base 10 of the electrostatic clamping 100 is made of an insulating material. In this embodiment, the base 10 is made of sintered ceramics. However, the material and arrangement of the base 10 of the electrostatic clamping 100 applicable to this embodiment are not limited to those described above. For example, only the clamping surface 120 of the electrostatic clamping 100 may also be made of an insulating material.

When receiving a voltage applied from the clamping power supply 150, the clamping electrode 101 generates static electricity that generates an electrostatic clamping force on the clamping surface 120. Consequently, the glass substrate 200 placed on the clamping surface 120 of the electrostatic clamping 100 is fixed to the clamping surface 120.

Also, the glass substrate 200 decreases the volume resistivity when heated. When fixing the glass substrate 200 by electrostatic clamping of the electrostatic clamping 100, therefore, a strong electrostatic clamping force can be generated by heating the glass substrate 200. The built-in heater 102 is used to heat the glass substrate 200 placed on the clamping surface 120 of the electrostatic clamping 100.

In addition, the evacuation through hole 111 is used to evacuate a small space formed between the clamping surface 120 of the electrostatic clamping 100 and the glass substrate 200 placed on the clamping surface 120, e.g., a groove for supplying helium gas or the like for improving the cooling effect, thereby fixing the glass substrate 200 on the clamping surface 120 by vacuum suction. This vacuum suction is normally performed to temporarily fix the glass substrate 200 on the clamping surface 120 before the electrostatic clamping 100 performs electrostatic clamping.

The clamping electrode 101, built-in heater 102, evacuation through hole 111, and vacuum pump 170 are general constituent elements of an electrostatic clamping. An electrostatic clamping cleaning method according to this embodiment removes foreign particles sticking to the clamping surface 120 of the electrostatic clamping by a simple method within a short time period by using these general constituent elements of the electrostatic clamping. The electrostatic clamping cleaning method according to this embodiment is executed by, e.g., a controller (not shown) that controls the overall operation of the display substrate manufacturing apparatus and the operation of the electrostatic clamping 100.

The process of the electrostatic clamping cleaning method will be explained below with reference to a flowchart shown in FIG. 1B. This electrostatic clamping cleaning method is executed as processing forming a part of the display substrate manufacturing method.

When the electrostatic clamping 100 is repetitively used in a substrate processing apparatus such as a semiconductor manufacturing apparatus or flat panel display manufacturing apparatus, foreign particles produced by substrate processing adhere to, e.g., the clamping surface 120 of the electrostatic clamping 100. These foreign particles attached to the clamping surface 120 decrease the clamping force to the glass substrate 200, and may produce the inconvenience that the glass substrate 200 moves during the substrate processing. Therefore, the foreign particles sticking to the clamping surface 120 must be removed. When clamping the glass substrate 200 by the electrostatic clamping 100, a clamping force check sequence is performed. The electrostatic clamping 100 is cleaned if it is detected that no predetermined clamping force is obtained.

In step S101, the controller executes the clamping force check sequence, and determines whether the clamping force of the electrostatic clamping 100 is a predetermined clamping force. If no predetermined clamping force is obtained, the process advances to step $102. On the other hand, if it is determined in step S101 that the predetermined clamping force is obtained, the process shown in FIG. 1B is terminated without executing any electrostatic clamping cleaning method.

When cleaning the electrostatic clamping 100 (NO in S101), a dummy glass substrate as clean raw glass is placed on the clamping surface 120 of the electrostatic clamping 100 (S102). To clamp the placed dummy glass substrate to the clamping surface 120, a voltage generated by the clamping power supply 150 is applied to the clamping electrode 101. The dummy glass substrate is clamped to the clamping surface 120 by generating an electrostatic clamping force (S102).

Then, the vacuum pump 170 is operated to evacuate the interior of a small space between the clamping surface 120 and dummy glass substrate through the evacuation through hole 111 (S103). The evacuation pressure is set at, e.g., 1 Pa or less. This evacuation brings the dummy glass substrate in tight contact with the clamping surface 120.

While evacuation is performed as described above, the built-in heater power supply 160 applies a voltage to the built-in heater 102 to heat the base 10 of the electrostatic clamping 100 to a predetermined temperature, e.g., 120° C., and this heated state at the predetermined temperature is maintained for a predetermined time (e.g., 120 min in this embodiment) (S104). This heating facilitates removing, from the clamping surface 120, foreign particles sticking to the clamping surface 120.

In step S105, the foreign particles attached to the clamping surface 120 are transferred from the clamping surface 120 to the dummy glass substrate in tight contact with the clamping surface 120.

After that, the vacuum state of the small space formed between the clamping surface 120 and dummy glass substrate is returned to the atmospheric pressure state by stopping the vacuum pump 170 (S106), and the temperature of the base 10 of the electrostatic clamping 100 is decreased by stopping the voltage application from the built-in heater power supply 160 (S107). The dummy glass substrate is then held by a robot arm (not shown) and carefully raised above the electrostatic clamping 100, thereby removing the dummy glass substrate from the clamping surface 120 of the electrostatic clamping 100 (S108). By thus removing the dummy glass substrate from the clamping surface 120, the foreign particles transferred to the dummy glass substrate are removed from the clamping surface 120, thereby cleaning the clamping surface 120.

The method of cleaning the electrostatic clamping 100 is completed as described above.

The cleaning method of the electrostatic clamping 100 according to this embodiment facilitates removing, from the clamping surface 120 of the electrostatic clamping 100, foreign particles attached to the clamping surface 120 by heating the base 10 of the electrostatic clamping 100 by the built-in heater 102. In this state, the glass substrate 200 is brought into tight contact with the clamping surface 120 by evacuating the small space between the clamping surface 120 and glass substrate 200, thereby transferring the foreign particles sticking to the clamping surface 120 to the glass substrate 200.

In this case, some foreign particles may be removed from the clamping surface 120 as they are evaporated in the vacuum ambient. The foreign particles sticking to the clamping surface 120 of the electrostatic clamping 100 can be removed from the clamping surface 120 as they are thus transferred to the glass substrate 200. This makes it unnecessary to disassemble and detach the electrostatic clamping 100 from the substrate processing apparatus in order to clean the clamping surface 120 of the electrostatic clamping 100. Accordingly, the operation of cleaning the electrostatic clamping 100 can be simply performed within a short time.

In the above embodiment, the step (S104) of heating the base 10 of the electrostatic clamping 100 is performed following the step (S103) of evacuating the interior of the small space formed between the clamping surface 120 and glass substrate 200. However, the order of these steps is not limited to this one; it is also possible to perform the step (S104) of heating the base 10 of the electrostatic clamping 100 before the step (S103) of evacuating the interior of the small space formed between the clamping surface 120 and dummy glass substrate 200.

Also, in the above embodiment described above, the process of cleaning the electrostatic clamping 100 is executed on the basis of the result of that determination on whether the clamping force of the electrostatic clamping 100 is a predetermined clamping force, which is performed in step S101 as processing forming a part of the display substrate manufacturing method. However, the spirit and scope of the present invention are not limited to this embodiment. For example, the process of cleaning the electrostatic clamping 100 may also be executed when the accumulated number of processed substrates exceeds a predetermined reference number. The process of cleaning the electrostatic clamping 100 can be executed while the display substrate manufacturing apparatus is not in operation. The execution timing can be set between normal substrate processing steps, or in the periodical maintenance period of the display substrate manufacturing apparatus. That is, the process of cleaning the electrostatic clamping 100 of this embodiment can be executed any time while the display substrate manufacturing apparatus is not in operation.

Note that it is also possible to remove foreign particles attached to the clamping surface 120 of the electrostatic clamping 100 by decomposing the foreign particles by generating a plasma in the substrate processing apparatus. In this case, however, the foreign particles removed by decomposition scatter in the substrate processing apparatus and adhere to the inner walls and the like. This newly makes it necessary to clean the interior of the substrate processing apparatus. By contrast, the cleaning method of this embodiment can remove foreign particles by transferring them to the glass substrate 200. Since, therefore, almost no foreign particles scatter, the cleaning process can be performed in a clean state. Furthermore, the glass substrate 200 to which foreign particles have been transferred can be used any number of times by washing away the foreign particles. This embodiment uses the glass substrate 200 made of raw glass as a member to which foreign particles are transferred. However, it is also possible to use a member made of another inexpensive material, provided that the member has durability against the temperature rise described above and is a clean smooth plate-like member.

In the cleaning step described above, the glass substrate 200 is brought into tight contact with the clamping surface 120 of the electrostatic clamping 100 by only evacuation by the vacuum pump 170. To generate a stronger contact force, however, the glass substrate 200 may also be brought into contact with the clamping surface 120 of the glass substrate 200 by an electrostatic clamping force generated by applying a voltage to the clamping electrode 101, in addition to suction by evacuation.

Although FIG. 1A shows the arrangement including the bipolar clamping electrode 101, the configuration of the electrostatic clamping 100 is not limited to this arrangement. That is, a configuration including a unipolar clamping electrode may also be used.

Note that if the clamping surface 120 of the electrostatic clamping 100 cannot be well cleaned by the cleaning step described above, the same step as above is performed by setting the time during which evacuation and heating are maintained at 240 min. If it is still impossible to clean well the clamping surface 120, the same step as above is performed by setting the time during which evacuation and heating are maintained at 720 min. The clamping surface 120 of the electrostatic clamping 100 can be well cleaned by thus repeating the cleaning step.

FIG. 2 is a perspective view showing an outline of the arrangement of a flat panel display film formation apparatus as an example of the vacuum processing apparatus to which the present invention is applicable.

In this apparatus shown in FIG. 2, a plurality of electrostatic clamping members 100a having the same size are arranged in a matrix on an electrostatic clamping layout base 130, thereby forming an electrostatic clamping 2100. The vacuum processing apparatus includes a vacuum chamber (not shown) containing at least the electrostatic clamping 2100.

The electrostatic clamping 2100 shown in FIG. 2 can clamp and support large substrates because the total area of clamping surfaces 120 is large. Each electrostatic clamping member 100a has the same arrangement as that of the electrostatic clamping shown in FIG. 1A. Also, all the electrostatic clamping members 100a can have the same size. However, all the electrostatic clamping members 100a are connected together to a clamping power supply 150, built-in heater power supply 160, and vacuum pump 170. More specifically, the clamping power supply 150 is connected, via a clamping power supply distribution terminal 151, to a plurality of clamping electrodes (not shown) formed in the electrostatic clamping members 100a. The built-in heater power supply 160 is connected, via a heater power supply distribution terminal 161, to a plurality of built-in heaters (not shown) formed in the electrostatic clamping members 100a. The vacuum pump 170 is connected, via an evacuation piping distribution/branching manifold 171, to a plurality of evacuation through holes 111 formed in the electrostatic clamping members 10a.

In this large-sized apparatus as described above, the step of cleaning the clamping surfaces 120 of the electrostatic clamping 2100 can be performed in the same manner as the cleaning step explained with reference to FIG. 1A. Therefore, foreign particles sticking to the clamping surfaces 120 of the electrostatic clamping 2100 can be removed from the clamping surfaces 120 by transferring the foreign particles to a glass substrate placed on the clamping surfaces 120 of the electrostatic clamping 2100. The advantage of the cleaning method of this embodiment is that it is unnecessary to disassemble and remove the electrostatic clamping 2100 from the substrate processing apparatus in order to clean the clamping surfaces 120 of the electrostatic clamping 2100. This advantage is further effective when cleaning the electrostatic clamping installed in the large apparatus as described above.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-246904 filed Sep. 25, 2007 and Japanese Patent Application No. 2008-239708 filed Sep. 18, 2008, which are hereby incorporated by reference herein in their entirety.

What is claimed is:

1. A display substrate manufacturing method of a display substrate manufacturing apparatus having
a base having a clamping surface made of an insulating material,
an electrode formed inside the base to generate an electrostatic clamping force for clamping a substrate placed on the clamping surface,
heating means formed inside the base to heat the base, and
evacuating means for evacuating an interior of a space formed between the substrate placed on the clamping surface and the clamping surface,
the method comprising:
a placing step of placing a dummy substrate different from the substrate on the clamping surface;
an evacuating step of evacuating the interior of the space by the evacuating means, in order to bring the dummy substrate into tight contact with the clamping surface;
a heating step of heating the base by the heating means, in order to facilitate removing, from the clamping surface, foreign particles sticking to the clamping surface;
a transferring step of transferring the foreign particles sticking to the clamping surface from the clamping surface to the dummy substrate in tight contact with the clamping surface; and
a removing step of removing, from the clamping surface, the dummy substrate to which the foreign particles are transferred in the transferring step.

2. The method according to claim 1, wherein the space is used to supply helium gas for improving a cooling effect.

3. A display substrate manufacturing method of a display substrate manufacturing apparatus having
a base having a clamping surface made of an insulating material,
an electrode formed inside the base to generate an electrostatic clamping force for clamping a substrate placed on the clamping surface,
heating means formed inside the base to heat the base, and
evacuating means for evacuating an interior of a space formed between the substrate placed on the clamping surface and the clamping surface,
the method comprising:
a placing step of placing a dummy substrate different from the substrate on the clamping surface;
a heating step of heating the base by the heating means, in order to facilitate removing, from the clamping surface, foreign particles sticking to the clamping surface;
an evacuating step of evacuating the interior of the space by the evacuating means, in order to bring the dummy substrate into tight contact with the clamping surface;
a transferring step of transferring the foreign particles sticking to the clamping surface from the clamping surface to the dummy substrate in tight contact with the clamping surface; and
a removing step of removing, from the clamping surface, the dummy substrate to which the foreign particles are transferred in the transferring step.

4. The method according to claim 3, wherein the space is used to supply helium gas for improving a cooling effect.

5. The method according to claim 1, wherein in the heating step, a state in which the dummy substrate is heated is maintained for a predetermined time.

6. The method according to claim 3, wherein in the heating step, a state in which the dummy substrate is heated is maintained for a predetermined time.

7. The method according to claim 1, wherein the placing step comprises a step of clamping the placed dummy substrate to the clamping surface by the electrostatic clamping force generated by applying a voltage to the electrode, in order to clamp the dummy substrate to the clamping surface.

8. The method according to claim 3, wherein the placing step comprises a step of clamping the placed dummy substrate to the clamping surface by the electrostatic clamping force generated by applying a voltage to the electrode, in order to clamp the dummy substrate to the clamping surface.

9. The method according to claim 1, wherein the method is executed when the accumulated number of processed substrates exceeds a predetermined reference number.

10. The method according to claim 3, wherein the method is executed when the accumulated number of processed substrates exceeds a predetermined reference number.

11. A vacuum processing apparatus comprising:
an electrostatic clamping formed by arranging a plurality of electrostatic clamping members in the same plane, each electrostatic clamping member including a base having a clamping surface made of an insulating material, an electrode formed inside said base to generate an electrostatic clamping force for clamping a substrate placed on the clamping surface, heating means formed inside said base to heat said base, and an evacuation through hole formed through said base to communicate with the clamping surface;
a clamping power supply which applies a voltage to said electrode formed in each of the plurality of electrostatic clamping members;
a heater power supply which applies a voltage to said heating means formed in each of the plurality of electrostatic clamping members; and
a vacuum pump connected to said evacuation through hole formed in each of the plurality of electrostatic clamping members.

12. The apparatus according to claim 11, wherein said electrostatic clamping members are equally separated.
